(19) United States
(12) Patent Application Publication
(10) Pub. No.: US 2014/0377489 A1
(43) Pub. Date: Dec. 25, 2014

(54) NOVEL RESIN-IMPREGNATED FIBER TUBE FOR THE INNER LINING OF DUCTS AND PIPELINES AND PROCESS FOR PRODUCING THE RESIN-IMPREGNATED FIBER TUBE

(71) Applicant: BRANDENBURGER PATENTVERWERTUNG GBR, Landau (DE)

(72) Inventor: RUEDIGER KINZEBACH, LUDWIGSHAFEN (DE)

(21) Appl. No.: 14/479,513

(22) Filed: Sep. 8, 2014

Related U.S. Application Data
(63) Continuation of application No. PCT/EP2012/005282, filed on Dec. 20, 2012.

(30) Foreign Application Priority Data
Mar. 8, 2012 (DE) 102012004422.4

(51) Int. Cl. F16L 55/165; C08K 5/21; B29C 70/02

(52) U.S. Cl. CPC F16L 55/1656; B29C 70/021; C08K 5/21; B29K 2031/00
USPC 428/36.1; 264/165; 264/495; 252/182.12

(57) ABSTRACT

A resin-impregnated fiber tube for an inner lining of ducts and pipelines contains, in addition to identical or different types of fibrous material, at least one polymer reaction resin for impregnating the fibrous material and subsequent hardening, as well as at least one chemical additive based on urea or a chemically modified urea, wherein the chemical additive acts as a thixotroping agent. The resin-impregnated fiber tube may also contain a thickening agent, wherein oxides or hydroxides of alkaline earth metals are preferably used. The resin-impregnated fiber tube is preferably hardened by UV light.

### CROSS-REFERENCE TO RELATED APPLICATION

This is a continuation application, under 35 U.S.C. §120, of copending international application No. PCT/EP2012/005282, filed Dec. 20, 2012, which designated the United States; this application also claims the priority, under 35 U.S.C. §119, of German patent application No. DE 10 2012 004 422.4, filed Mar. 8, 2012; the prior applications are herewith incorporated by reference in their entirety.

### BACKGROUND OF THE INVENTION

### Field of the Invention

This invention concerns a novel resin-saturated fibrous tube for lining conduits and pipework lines by using a novel chemical additive as a fibrous tube or a fibrous tape that is impregnated with a liquid resin. The present invention further relates to a process for producing such a resin-saturated fibrous tube.

Buried wastewater conduits, water lines or other pipe work systems are frequently remediated without first having to dig up the entire length of the pipe work system by the very elegant technique of a flexible fibrous tube saturated with a liquid resin being introduced into the pipe, inflated therein, typically with compressed air, and the liquid resin then being cured. However, it is frequently observed that the liquid resin can drain from the fibrous tube after impregnation or at least accumulate on the bottom side of the tube.

European patent EP 799 397 therefore proposes saturating a three-ply glass fiber tube having an inner ply of a bulky fibrous mat and two outer plies of a woven roving fabric with a low-viscosity liquid resin and to gel an outer layer by UV irradiation. Yet to produce a three-ply fibrous tube of this type is costly and inconvenient. In addition, the problem with such a three-ply fibrous tube is that the resin in the bulky inner ply can settle out in the downward direction during storage, resulting in a nonuniform impregnation of the fibrous tube.

The European patent specification also describes a different way to produce a resin-saturated fibrous tube whereby thixotroping or thickening agents are supposed to be used after the impregnating step to increase the viscosity of the liquid resin in order thereby to prevent leakage of low-viscosity liquid resin fractions.

However, a procedure of this type has the disadvantage that the rate of impregnation appreciably decreases and that the wetting of individual fibers with the liquid resin is incomplete.

International patent disclosure WO 2006/061129 (corresponding to U.S. patent publication Nos. 2007/0272352 and 2012/0043006) further describes a process for producing a likewise resin-saturated fibrous tube for lining conduits or pipe work lines by impregnating with a liquid resin wherein a certain viscosity is always supposed to be set during and after the actual impregnating. The process additionally utilizes thickening agents, in particular oxides or hydroxides of alkaline earth metals and also optionally thixotroping agents. The thixotroping agents mentioned therein are compounds of silicic acid.

Convenient visual tracking of the progressive cure of the resin-saturated fibrous tube requires that the fibrous tube be as transparent as possible. Yet prior art resin-saturated fibrous tubes do not always possess good transparency. It is further desirable that the wall thickness of the resin-saturated fibrous tubes be as high as possible. Wall thickness is limited to a maximum of 13 mm for prior art fibrous tubes. However, there are some purposes for which it would be beneficial to be able to use fibrous tubes having a higher wall thickness that are obtainable at very low cost and inconvenience.

### SUMMARY OF THE INVENTION

Proceeding from the disadvantages of prior art fibrous tubes, therefore, the present invention has for its object to provide a novel resin-saturated fibrous tube that has a good level of transparency and an enhanced level of wall thickness. The present invention further has for its object to provide a very simple and speedy process for producing such a fibrous tube.

The resin-saturated fibrous tube which the present invention provides for lining conduits and pipe work lines contains not only the same or different types of fibrous materials but also at least one polymeric liquid resin for impregnating these fibrous materials and also at least one chemical additive based on urea or on a chemically modified urea and acting as a thixotroping agent.

The resin-saturated fibrous tube of the present invention preferably further contains an agent for thickening the liquid resin, in particular an oxide or a hydroxide of alkaline earth metals such as, for example, magnesium or calcium. The thickening agent used in particular is magnesium oxide, for example LUVATOL from Lehmann & Voss.

The fibrous tube of the present invention preferably consists of 40 to 50 weight percent of at least one polymeric liquid resin, 40 to 50 weight percent of the same or different types of fibrous materials, 0 to 5 weight percent of one or more thickening agents and 0.1 to 5 weight percent of the chemical additive based on urea or on chemically modified urea, the additive being used as a thixotropic agent, wherein the weight percentages always sum to 100%. Particularly preferred fibrous tubes contain 42 to 49, in particular 45 to 48 weight percent of at least one polymeric liquid resin, 42 to 49, in particular 45 to 48 weight percent of the same or different types of fibrous materials, 0.5 to 4, in particular 1 to 2.5 weight percent of a thickening agent and 0.5 to 5, in particular 0.7 to 4.5 weight percent of the chemical additive based on urea or on chemically modified urea. The individual weight percentages always add up to a sum total of 100 weight percent.

Suitable polymeric liquid resins include inter alia solutions of an unsaturated polyester or of a vinyl ester in styrene, polyacrylates, or polymethacrylates. Polymeric liquid resins of this type initially enclose the individual fibers of the fibrous materials and subsequently cure such that the fibers become completely enclosed by a solid polymeric resin. This stops reactive chemistries out of the conduits or pipe work systems from being able to attack the individual fibers.

The polymeric liquid resins are preferably cured by admixing a photoinitiator to the resin and irradiating with light of a suitable wavelength, especially with UV light from a UV light source which contains 2 or more, for example 2 or more UV lamps, preferably disposed in a chain one behind the other. Alternatively, the polymeric liquid resin may be cured by admixing a peroxide initiator. In the latter case, the cure is triggered by raising the temperature to above the disintegration temperature of the peroxide or, in the case of cold-curing liquid resins, by adding an accelerant.

The fibrous materials present in the fibrous tube of the present invention may be inter alia a woven fabric, a laid fabric, a mat, a nonwoven fabric, for example a needle punched nonwoven fabric or a felt, and also combinations of such fibrous structures. The individual fibers typically are formed of natural materials such as, for example, of wood or plant constituents. The fibers used may further consist of inorganics such as, for example, of glass or minerals. The fibers may further be constructed of manufactured polymerics such as inter alia of polyester fibers or polyamide fibers or of fibers containing copolymers formed from suitable monomers.

The resin-saturated fibrous tube of the present invention further additionally contains a chemical additive based on urea or on a chemically modified urea. Modified urea shall herein be understood as referring to such a urea as is substituted by suitable organic moieties, for example by alkyl groups or by aryl groups, on either or both of the amino functions of the urea molecule. Such alkyl groups or aryl groups may in turn likewise be subjected to modification. Such a chemical additive based on urea or on chemically modified urea acts as some sort of thixotroping agent which serves to re-elevate the viscosity of the resin-saturated fibrous tube after terminating the mechanical loading as the fibrous tube expands. One highly suitable chemical additive for the resin-saturated fibrous tube of the present invention is available from BYK-Chemie under the trade name BYK-LP R 21400. This additive is typically in liquid form, preferably in a suitable solvent, and hence is readily meterable. Particular preference is given here to an additive based on a modified urea of a polyurethane dissolved in N-methylpyrrolidone, dimethyl sulfoxide or in N-ethylpyrrolidone.

To ensure that the fibrous materials are adequately saturated with the initially liquid resin, it is preferable not to use too much of the chemical additive based on urea or on modified urea. It is accordingly advisable to use not more than 5 weight percent of such a chemical additive based on the overall amount of the resin-saturated fibrous tube.

Using an additional thickening agent in an excessive amount may lead to some deterioration in the transparency of the resin-saturated fibrous tube. It is accordingly advisable to raise the proportion of the total amount of the resin-saturated fibrous tube which is represented by the thickening agent to not more than 5 weight percent.

After the impregnating step has ended, the fibrous tube of the present invention has a viscosity of about 50,000 to 2,000,000 mPa. Such a range of viscosity ensures adequate flowability on the part of the liquid resin during curing, making it possible to prevent surface defects. On the other hand, however, this viscosity range is sufficiently high to prevent the liquid resin from being squeezed out of the fibrous tube as the fibrous tube is being inflated with compressed air.

The resin-saturated fibrous tube of the present invention is notable inter alia for a high level of mechanical stability over a period of decades. It further possesses enhanced transparency compared with the prior art resin-saturated fibrous tubes, permitting better visual inspection of curing. The fibrous tube of the present invention may further also be photocured with UV to higher wall thicknesses of up to 15 mm without need for some additional admixture of organic peroxides, while UV-curable prior art fibrous tubes only have wall thicknesses of not more than 13 mm.

The fibrous tube of the present invention may be provided both on the inside and on the outside with appropriate films in polyethylene or polypropylene, for example, to improve its storage. To remediate wastewater conduits, water lines or other pipe work systems, the fibrous tube of the present invention is drawn into these and inflated therein, typically with compressed air, so it conforms to the inner surface and then the liquid resin is cured.

The present invention further also provides a process for producing a resin-saturated fibrous tube for lining conduits and pipe work lines by impregnating a fibrous tube with a liquid resin. The actual impregnation with a liquid resin may also be carried out earlier at a fibrous tape stage, in which case the liquid resin first acts on the fibrous tape. The fibrous tape is subsequently wound around a mandrel until a corresponding fibrous tube has formed.

In the process of the present invention, the same or different types of fibrous materials are initially admixed with the liquid resin preferably at temperatures of 5° C. to 40° C., in particular at temperatures of 15° C. to 30° C. such that as many fibers as possible are wetted by the liquid resin. This is followed by adding the chemical additive based on urea or on a chemically modified urea preferably at temperatures of 15° C. to 30° C. in liquid form.

In one preferred version of the process according to the present invention, the mixture of fibrous materials, liquid resin and chemical additive based on urea is further additionally admixed with a thickening agent in the form of a pulverulent solid or in the form of a paste dispersed in a liquid vehicle.

The process of the present invention makes for distinctly speedier production of a fibrous tube than the prior art processes.

Other features which are considered as characteristic for the invention are set forth in the appended claims.

Although the invention is described herein as embodied in a novel resin-impregnated fiber tube for the inner lining of ducts and pipelines and a process for producing the resin-impregnated fiber tube, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### DETAILED DESCRIPTION OF THE INVENTION

The invention is hereinbelow still further elucidated by an inventive example and a comparative example representing the prior art.

### Example 1

1 kg of a fibrous tape containing of 48 weight percent of glass fibers and 48 weight percent of a liquid resin was impregnated at 5-40° C. for 0.5-10 minutes. In addition to the liquid resin and the glass fibers, this mixture further contained—based on 100%—2 weight percent of magnesium oxide (Luvatol EK 30 nV from Lehmann & Voss) as thickening agent and 2 weight percent of urea compound (BYK-LP R 21400 from BYK Chemie), the latter ones being referred to as a chemical additive. The thickening agent and the urea compound were left to act on the fibrous tape at 5-40° C. for altogether 3-6 hours. The fibrous tape was then wound onto a mandrel overlappingly until a fibrous tube having a wall thickness of 15 mm had formed. The fibrous tube was thereafter cured from its interior using UV light (wavelength 300-500 nm).

### Comparative Example A

Inventive Example 1 was repeated except that the urea compound was replaced by the analogous amount of silica (WACKER HDK from Wacker-Chemie). The impregnated fibrous tape was cured under the same conditions as in Inventive Example 1.

A comparison between Inventive Example 1 and Comparative Example A revealed that the inventive fibrous tube had a more than 20% higher transparency to visible light and UV light and could be processed into fully through-cured pipes having a wall thickness of 15 mm. The maximum wall thickness with the fibrous tube of Comparative Example A was only 13 mm.

It was further possible to carry out the production of the inventive fibrous tube within about 5 to 6 hours, while the fibrous tube of Comparative Example A had to be processed for about two days.

1. A resin-saturated fibrous tube for lining conduits and pipe work lines, the resin-saturated fibrous tube comprising:
a fibrous material;
at least one curable polymeric liquid resin impregnating said fibrous material; and
at least one chemical additive based on urea or a chemically modified urea, wherein said chemical additive acting as a thixotroping agent.

2. The resin-saturated fibrous tube according to claim 1, further comprising an thickening agent for thickening said curable polymeric liquid resin.

3. The resin-saturated fibrous tube according to claim 2, wherein said thickening agent used for thickening said curable polymeric liquid resin is selected from the group consisting of an oxide of alkaline earth metals, a hydroxide of alkaline earth metals, an oxide of magnesium, an oxide of calcium, a hydroxide of magnesium and a hydroxide of calcium.

4. The resin-saturated fibrous tube according to claim 2, further comprising:
said at least one curable polymeric liquid resin being 40 to 50 weight percent;
said fibrous material being 40 to 50 weight percent of a same or different types of fibrous materials;
said thickening agent being 0 to 5 weight percent; and
said chemical additive being 0.1 to 5 weight percent.

5. The resin-saturated fibrous tube according to claim 4, further comprising:
42 to 49 weight percent of said at least one curable polymeric liquid resin;
42 to 49 weight percent of said fibrous material;
0. 5 to 4 weight percent of said thickening agent; and
0.5 to 5 weight percent of said chemical additive.

6. The resin-saturated fibrous tube according to claim 1, wherein said curable polymeric liquid resin is selected from the group consisting of solutions of a polyester or a vinyl ester in styrene, polyacrylates and polymethacrylates.

7. The resin-saturated fibrous tube according to claim 1, wherein said fibrous material has glass fibers.

8. The resin-saturated fibrous tube according to claim 1, wherein said fibrous material is selected from the group consisting of a laid fabric, a woven fabric, and a nonwoven fabric.

9. The resin-saturated fibrous tube according to claim 1, wherein said chemical additive is a urea-based chemical additive containing a modified urea of a polyurethane dissolved in N-methylpyrrolidone, dimethyl sulfoxide or N-ethylpyrrolidone.

10. The resin-saturated fibrous tube according to claim 5, further comprising:
45 to 48 weight percent of said at least one curable polymeric liquid resin;
45 to 48 weight percent of said fibrous material;
1 to 2.5 weight percent of said thickening agent; and
0.7 to 4.5 weight percent of said chemical additive.

11. A process for producing a resin-saturated fibrous tube, which comprises the steps of:
admixing a fibrous material having fibers with a liquid resin at temperatures of 5° C. to 40° C. for wetting the fibers via the liquid resin; and
adding a chemical additive based on urea or on chemically modified urea to the liquid resin before the wetting of the fibrous material with the liquid resin.

12. The process according to claim 11, which further comprises additionally admixing a thickening agent to a mixture of the fibrous material, the liquid resin and the chemical additive.

13. The process according to claim 11, which further comprises:
providing the liquid resin with a photo-initiator; and
curing the resin-saturated fibrous tube with UV light after the fibrous material has been wetted.

14. The process according to claim 11, which further comprises:
admixing the fibrous material having the fibers with the liquid resin at temperatures of 15° C. to 30° C. for wetting the fibers via the liquid resin; and
adding the chemical additive based on urea or on chemically modified urea to the liquid resin before the wetting of the fibrous material with the liquid resin at a temperature of 15° C. to 30° C.

15. The process according to claim 12, which further comprises providing the thickening agent in a form of a pulverulent solid or in a form of a paste dispersed in a liquid vehicle.

16. A production method, which comprises the step of providing a modified urea as a thixotroping agent in a liquid resin in a production of a fibrous tube saturated with a liquid resin.
